(19) United States
(12) Patent Application Publication
(10) Pub. No.: US 2009/0251900 A1
(43) Pub. Date: Oct. 8, 2009

(54) LAMP AND DEVICE FOR PREVENTING THE DISPERSION OF LIGHT IN UNDESIRED DIRETIONS

(76) Inventors: Giampaolo Targetti, Firenze (IT); Andrea Donnini, Firenze (IT)

Correspondence Address: POLLACK, P.C., THE CHRYSLER BUILDING, 132 EAST 43RD STREET, SUITE 760, NEW YORK, NY, 10017, US

(21) Appl. No.: 12/310,101

(22) PCT Filed: Jul. 23, 2007
(86) PCT No.: PCT/IB2007/052920

§ 371 Date: Feb. 9, 2009

(30) Foreign Application Priority Data
Aug. 9, 2006 (IT) FI2006A000204

(51) Int. Cl. F21V 11/02

(52) U.S. Cl. 362/291

(57) ABSTRACT

A lamp having a base housing with a member for connection to a lamp-holder, and a light source extending generally axially from the housing. The lamp includes a device connected to the housing suitable for screening the dispersion of the light radiation in undesired directions. Such device preferably comprises a hood with a generally cylindrical grid arranged coaxially to the housing and enclosing the light source. Desireably, the grid is formed from a plurality of substantially frusto-conical rings axially superimposed, joined and regularly spaced by a plurality of axial ribs.

### FIELD OF THE INVENTION

The present invention concerns the field of lighting apparatuses and in particular refers to a new type of lamp with the capacity of preventing the dispersion of light in undesired directions.

### BACKGROUND OF THE INVENTION

Increasing attention is devoted to problems related with the dispersion of light in undesired directions. More specifically, in street lighting and, more generally, lighting of open spaces, such dispersion generates an alteration of the light levels naturally present in the night-time. This alteration, above and beyond the economic damage due to the wasted electrical energy used to pointlessly light areas that should not be lit, gives rise to negative environmental and cultural consequences. Indeed, this alteration can influence the natural biological rhythms and behaviours of plants, animals (which frequently, as a result, may have orientation difficulties or get lost) and of man. Since it becomes more difficult, and sometimes even impossible, to contemplate at the starry sky, in addition to the obvious cultural damage, the possibilities of astronomical observation of the night sky are compromised.

Considering this, lighting apparatuses are often equipped with suitable grids that allow the light emitted by the light source to be directed, screening it in the directions not desired. This solution indeed implies that the apparatus as a whole is specially designed, and in any case the distance between the light source and the grid, necessary in order to ensure that the lamp can be removed, is such that the reduction of dispersion is not totally satisfactory.

### SUMMARY OF THE INVENTION

According to the present invention, a more effective solution to the problem outlined above is now provided, further improving the screening capabilities in apparatuses already provided with suitable grids, and allowing that all lighting apparatuses and installations originally lacking light screening capabilities can be equipped with full light dispersion prevention function.

This object is achieved with the lamp and the device according to the invention, the essential features of which are defined, respectively, in the attached claims 1 and 9.

### BRIEF DESCRIPTION OF THE DRAWINGS

The characteristics and advantages of the lamp and of the device for preventing the dispersion of light in undesired directions according to the present invention shall become clearer from the following description of its embodiments, given purely as non-limiting examples, with reference to the attached drawings, in which:

FIG. 1 is a perspective view of a lamp according to the present invention;

FIG. 2 is an axial section view of the lamp of FIG. 1; and

FIGS. 3 and 4 represent perspective exploded views, from respective different angles, of the lamp of the previous figures.

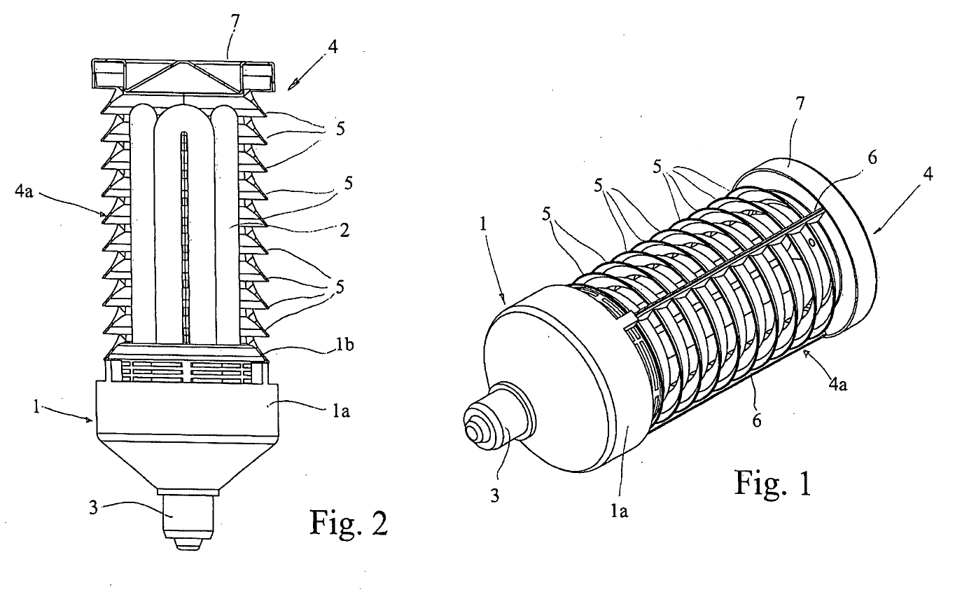

### DETAILED DESCRIPTION OF THE INVENTION

With reference to the above figures, the lamp according to the present invention has a general structure fully in accordance with conventional lamps. Therefore, it shall, for example and typically, assume the characteristics of a common low-consumption, compact fluorescent lamp with a base housing 1 provided with a lamp plug 3 for connection to a lamp-holder, and a fluorescent tube 2, constituting the actual emission source of the light radiation, on the opposite side to the plug 3. The housing 1 contains the electronic circuitry intended for feeding and controlling the lamp, and comprises, again conventionally, a cylindrical portion 1a closed by a plate 1b from which the tube 2 axially projects.

According to the invention, the tube 2 is enclosed by a hood 4 made from material impermeable to light radiation (typically a plastic material) and generally cylinder-shaped, arranged coaxially about the tube itself. The hood 4 has an average diameter sufficient to receive the bulk of the tube 2 so that it fits perfectly. In the illustrated embodiment such a diameter is slightly smaller than that of the cylindrical portion 1a of the housing 1, with which it engages in correspondence with the plate 1b.

The hood 4 has a grid-shaped structure 4a defined by a plurality of rings 5 joined by thin axial ribs 6 so as to be regularly spaced apart axially. The axial ribs 6 are equally angularly spaced, and in a number such as not to create significant obstruction of the space between the rings. Three ribs, like in the illustrated example, normally represent the optimal number. The rings 5 are substantially frusto-conical shaped, in the example with decreasing diameter moving away from the housing 1, the pitch between the rings (i.e. the distance between corresponding points of one ring and the next one), being slightly greater than the thickness (bulk of the ring measured axially).

The hood 4 is completed by a disc-shaped cap 7 that, arranged perpendicular to the axis of the lamp and of the grid, closes the free end of the cylindrical grid 4a, i.e. the opposite end to that engaged with the plate 1b of the housing 1. In the example, the diameter of the cap 7 is greater than the maximum diameter of the rings 5, and substantially corresponds to the diameter of the cylindrical portion 1a of the housing 1.

The conicity of the rings 5, in cooperation with the interception due to the cap 7, ensure that the light radiation captured by them is conveyed by reflection in the desired direction, i.e. towards the housing 1, preventing undesired dispersion in the opposite direction. In particular, the conicity is selected so as to prevent the reflection of light beyond a direction perpendicular to the axis of the lamp, i.e. according to an angle that does not exceed the horizontal in the case of a lamp arranged with vertical axis. Typically, the conicity can be approximately between 40° and 60°.

The illustrated solution is clearly suitable for a mounting of the lamp along a vertical axis, with the plug at the bottom, preventing the diffusion of light upwards. In the case of inverse mounting, the same construction can be used should one want to prevent diffusion of light downwards. Again with inverse mounting (plug at the top), a grid with conicity of the rings 5 that is inverted with respect to the previous example (i.e. with the diameter increasing moving away from the housing), can be used to screen the diffusion of light towards the housing, and therefore upwards. In this case, the cap 7 can even be omitted.

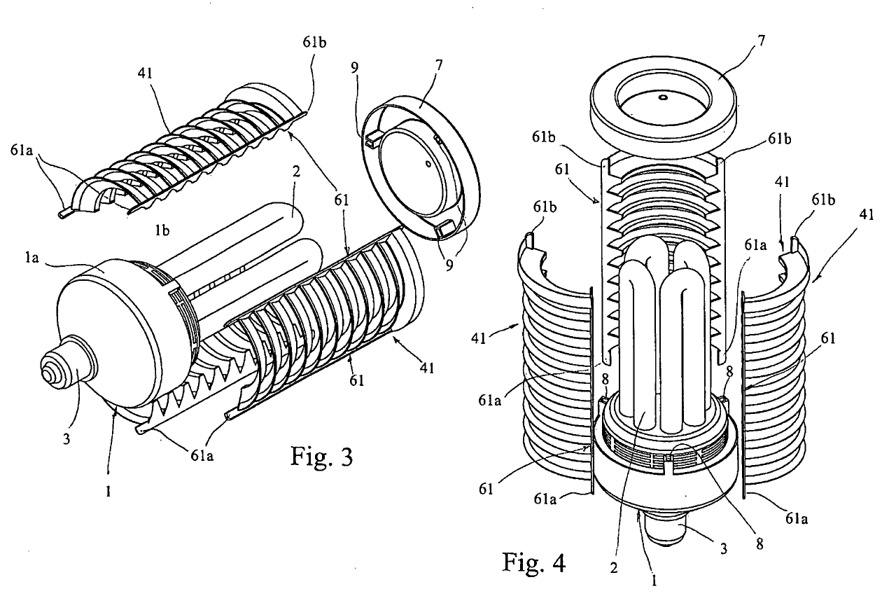

As mentioned, according to the invention the hood 4 is directly fixed to the cylindrical portion 1a of the housing 1. For this purpose, as shown in particular in FIGS. 3 and 4, the cylindrical grid 4a can advantageously be made up of a plurality of pieces 41, obtained by moulding, resulting from the division of the grid itself along the generatrices in correspondence with the ribs 6. Each piece 41 is therefore gut-like shaped, bordered by respective semi-elements 61 of the axial ribs 6. The semi-elements 61 have first ends 61a projecting downwards beyond the first ring 5 at the base of the grid. The first ends 61a engage, inserting axially and locking, possibly with the help of a glue, in suitable engagement seats 8 formed perimetrically on the plate 1b. On the opposite side the semi-elements 61 have second projecting ends 61b, intended to engage, similarly to what has just been mentioned for the first ends 61a, with engagement seats 9 formed perimetrically on the cap 7, which is thus engaged to complete the assembly of the hood 4.

The mounting of the hood 4 on the housing 1, with the advantageous method indicated above or with other appropriate systems, can be carried out in the production stage of the lamp. Alternatively, the hood 4 can be provided, both in kit and individually, as an accessory intended for application to the lamp by the user. In the case of marketing as an independent accessory, the hood can be equipped with an adaptor to allow its application to all lamps, in particular of the low-consumption fluorescent type, available on the market, which have housing diameters slightly variable from one to the other. Such an adaptor can simply assume the shaped of a ring to be engaged coaxially, forcibly or by snap engagement, with the housing 1, making the engagement seats 8 available in suitable position.

The above shows that thanks to the invention it is possible to effectively prevent light dispersion in undesired directions for apparatuses that currently lack this capability, but also to improve apparatuses already provided with the aforementioned function, all thanks to the fact that the light source is directly and intrinsically equipped with a system suitable for avoiding the dissipation of the radiation in undesired directions. The fact that the hood 4, precisely thanks to the direct assembly on the lamp, is arranged in the immediate proximity of the light source, allows a screening action of maximum efficiency to be achieved.

Above and beyond the example described and illustrated, it is clear that the configuration of the hood and of the relative assembly can vary, according to the configuration of the light source and of the relative base housing, as well as, as already mentioned, according to the direction in which one wishes to avoid dissipation/dispersion of light. In fact, numerous variants and/or modifications can be brought to the lamp and to the device for preventing the dispersion of light in undesired directions according to the present invention, without for this reason departing from the scope of protection of the invention itself as defined in the appended claims.

What is claimed is:

1. A lamp having a base housing with a member for connection to a lamp-holder, and a light source extending generally axially from the housing, the lamp including a device for screening the dispersion of the light radiation in undesired directions, connected to the housing.

2. The lamp set forth in claim 1, wherein the screening device has a hood with a generally cylindrical grid arranged coaxially to the housing and enclosing the light source, the grid comprising a plurality of axially superimposed, substantially frusto-conical rings, joined and spaced relatively uniformly from one another by a plurality of axial ribs.

3. The lamp set forth in claim 2, wherein the pitch between the rings is generally greater than the bulk of each ring measured axially.

4. The lamp set forth in claim 2, further comprising three generally equally, angularly spaced axial ribs.

5. The lamp set forth in claim 2, wherein the hood further comprises a substantially disc-shaped cap that, generally arranged normally to the axis of the grid, blocks its opening at a free end, the rings having a diameter that decreases generally with increasing distance from the housing.

6. The lamp according set forth in claim 2, wherein the grid comprises a plurality of pieces resulting from division of the grid along the generatrices corresponding to the respective ribs, each piece having a gut-like shape, bordered by respective semi-elements of each rib.

7. The lamp set forth in claim 6, wherein the semi-elements have respective first ends projecting beyond the ring at the base of the grid, for suitably engaging with first seats formed perimetrically in the housing.

8. The lamp set forth in claim 7, wherein the semi-elements have second ends projecting opposite to the first ends, for suitably engaging with second seats formed perimetrically in a cap for blocking the opening of the grid at the free end.

9. A device for preventing dispersion of light in undesired directions from a lamp comprising a base housing having a member for connection to a lamp-holder, and a light source extending axially from said housing, the device including a generally cylindrical grid arranged coaxially to the housing and enclosing the light source, the grid having a plurality of axially superimposed, substantially frusto-conical rings, joined and spaced relatively uniformly from one another by a plurality of axial ribs.

10. The device set forth in claim 9, wherein the pitch between the rings is generally greater than the bulk of each ring measured axially.

11. The device set forth in claim 9, further comprising three generally equally, angularly spaced axial ribs.

12. The device set forth in claim 9, further comprising a substantially disc-shaped cap that, generally arranged normally to the axis of the grid, blocks its opening at a free end, the rings having a diameter that decreases generally with increasing distance from from the housing.

13. The device set forth in claim 9, wherein the grid is made up of a plurality of pieces resulting from the division of the grid itself along the generatrices corresponding to the respective the ribs, each piece having a gut-like shape, bordered by respective semi-elements of each rib.

14. The device set forth in claim 13, the semi-elements having respective first and second projecting ends, for suitably engaging with seats formed perimetrically in the housing of the lamp or in an adapter to be secured to the housing, and in a cap for blocking the opening of the grid at the free end.

15. The device set forth in claim 14, wherein the adapter includes a ring engaged coaxially, by friction fit or snap-engagement, with the housing.
